(19) United States
(12) Patent Application Publication
(10) Pub. No.: US 2024/0083797 A1
(43) Pub. Date: Mar. 14, 2024

(54) MICRO-DOSING SYSTEM FOR USE WITH A WATER MINERALIZATION PROCESS

(71) Applicant: CORE PACIFIC INC., Houston, TX (US)

(72) Inventor: Patrick GWEN, Houston, TX (US)

(21) Appl. No.: 18/482,955

(22) Filed: Oct. 9, 2023

Related U.S. Application Data
(63) Continuation-in-part of application No. 18/175,998, filed on Feb. 28, 2023.
Application No. 18/175,998 is a continuation of application No. 17/815,479, filed on Jul. 27, 2022, now Pat. No. 11,597,669.

(51) Int. Cl. C02F 9/00

(52) U.S. Cl. CPC C02F 9/00; C02F 1/003

(57) ABSTRACT

A micro-dosing system for water mineralization process has a bottle with a liquid mineral or supplement therein, a cap affixed to the opening of the bottle, a pump connected to a channel of the cap and adapted to draw the liquid mineral or supplement through the channel, and a splitter connected to the pump and with the channel of the cap. The channel communicates with an interior volume of the bottle. The cap has a return passage formed therein. The return passage communicates with the interior volume of the bottle. The splitter has an outlet formed thereon. The outlet passes a portion of the liquid mineral or supplement from the channel of the cap. The splitter has a return line communicating with the return passage of the cap so as to pass remainder of the liquid mineral or supplement back through the return passage of the cap and into the interior volume of the bottle.

### CROSS-REFERENCE TO RELATED APPLICATIONS

The present application is a continuation-in-part of U.S. patent application Ser. No. 18/175,998, filed on Feb. 26, 2023, presently pending. U.S. patent application Ser. No. 18/175,998 is a continuation of U.S. patent application Ser. No. 17/815,479, filed Jul. 27, 2022, now U.S. Pat. No. 11,597,669, issued on Mar. 7, 2023.

### FIELD OF THE INVENTION

The present invention relates to water mineralization systems. Additionally, the present invention relates to the micro-dosing of minerals and supplements into filtered water of a water mineralization system.

### BACKGROUND OF THE INVENTION

In the art of water treatment, it is well-known to purify water for human consumption by implementing specific purifying processes. These purifying processes include, for example, the processes of filtration, sedimentation, bacterial digestion, distillation and reverse osmosis. In reverse osmosis, for example, a volume of liquid containing contaminants is introduced into a chamber on one side of a semi-permeable membrane (i.e. having pores large enough to pass the molecules of the liquid but not those of the solute contaminant). By pressurizing the liquid above its osmotic pressure, the liquid molecules will diffuse across the membrane but the solute molecules will remain. The resulting brine is then discarded and the liquid is thus purified and retained.

Such reverse osmosis systems can be configured to produce purified water from virtually any source and remove many of the contaminants contained therein, including dissolved mineral ions, with great effectiveness. While this is advantageous for many reasons and in many applications, it is nonetheless imperfect for the production of drinking water. Specifically, in the case of a reverse-osmosis process, it is not selective. In other words, it removes all dissolved mineral ions, both those which are desirable for health and taste along with those which are not. In the end, the produced water is a demineralized water free of any mineral ions and without taste.

It is therefore known to pass the demineralized water through a subsequent step for replenishing certain minerals lost and adding other desirable minerals not present in the water prior to the start of the purification process. In particular, calcium, magnesium and bicarbonate are particularly desirable. Their presence in drinking water may contribute to establishing and maintaining physical and mental health. These ions are also partly responsible for creating a pleasant taste in the drinking water.

One such means of doing this is to dissolve a mixture of mineral salts into the water. Commonly employed additives include calcium chloride, magnesium sulphate, chloride, bicarbonate of sodium, and potassium. However, the use of such salts will result in the presence of unwanted chloride, sulfate, sodium and potassium ions which can negatively affect the taste of water and bring a bitter and/or salty taste in the final product. At certain quantities, these can have deleterious effects on the health of certain sensitive customers (i.e. for people having specific diets, for example).

In the past, the minerals that are to be introduced into the filtered water are provided in a pellet form. Typically, the minerals are encapsulated in clay and slowly dissolve into the water. Unfortunately, the quality control of such mineral-bearing clay pellets is often inconsistent and minimal. As a result, the quality of the minerals, the quantity of the minerals, and the rate of mineral diffusion in the drinking water can be relatively uncontrolled. Under certain circumstances, the initial water washing across the mineral-bearing clay pellets will have a large amount of minerals therein. Later passages of water across the mineral-bearing clay pellets will have a lower mineral content. As such, the exact dosing of minerals into the drinking water is unavailable in the prior art.

It is the goal of the mineralization process to mineralize demineralized water with ions and minerals so as to establish and maintain physical and mental health while avoiding the undesirable ones for taste or health issues. It is therefore desirable to provide a means for mineralizing demineralized water with desirable ions, without also adding undesirable amounts, counter-ions and/or compounds.

In many countries, the average diet does not contain sufficient levels of necessary minerals and nutritions, such as, iron, zinc, iodine, vitamin A and vitamin B. Iron deficiency is well documented and is common in most developing countries. Recent evidence suggests that nutritional zinc deficiency may be overcome among the people of many developing countries where they subsist on diets of plant origin (e.g. cereal and legume). Marginal mineral deficiencies may be widespread even in the in the U.S. because of self-imposed dietary restrictions, use of alcohol and serial proteins, and the increasing use of refined foods that decrease the intake of trace minerals.

Many mineral deficiencies can be overcome by taking supplements. Other methods of addressing these deficiencies include increasing the intake of foods naturally containing these minerals or fortifying food and beverage products. Usually, in countries where the people suffer from these deficiencies, the economy is such that providing minerals and vitamins as a supplement is expensive and presents significant distribution logistics problems. In addition, compliance, i.e. having the people take the vitamin and mineral supplements on a daily basis, is a serious problem. Accordingly, the delivery of minerals, along with other vitamins and nutrients, in a form that has high bioavailability and at the same time a non-objectionable taste and appearance, and in a form that would be consumed by high proportion of the population at risk, is desirable.

There are well-recognized problems associated with adding both vitamins and minerals to beverages. Zinc supplements tend to have an objectionable taste, cause distortion of taste and cause mouth irritation. Iron supplements tend to discolor foodstuffs, or to be or organoleptic unsuitable. Moreover, it is particularly difficult to formulate products containing minerals and, in particular, mixtures of available iron and zinc. These minerals not only affect the organoleptic and aesthetic properties of beverages, but also undesirably affect the nutritional bioavailability of the minerals themselves and the stability of vitamins and flavors.

Several problems exist with delivering a mixture of iron and zinc with or without vitamins in a beverage mix. A few of the problems are choosing iron and zinc compounds which are organolepticably acceptable, bioavailable, cost-effective and safe. For example, the water-soluble iron and zinc compounds, which are the most viable available, cause unacceptable metallic aftertaste and flavor changes. In addition, the soluble iron complexes often cause unacceptable color changes. Even further, the iron complexes themselves are often colored. This makes formulating a dry powder that has a uniform color distribution in the mix more difficult. Often, the reconstituted beverage does not have a suitable color identifiable with the flavoring agent. Color and taste are key to consumer acceptance.

An even greater challenge has been faced in providing a mineral fortified drinking water that contains a bioavailable source of iron or zinc mineral. A drinking water, as opposed to a beverage, should contain water as its main ingredient, and which should have the taste and appearance of pure water. Fortification of drinking water with soluble, stable and bioavailable minerals (e.g. iron, zinc) has been a challenge. For example, when the soluble form of iron (ferrous iron) is added to regular water, it rapidly oxidizes to the insoluble trivalent form, which is ferric iron. Subsequently, the ferric iron combines with hydroxide ions to form iron hydroxide (yellow colored), which later converts to ferric oxide, a red, powdery precipitate called rust. Thus, it is well-known that natural water not only oxidizes iron from ferrous to ferric moieties, but also causes the development of undesirable color, poor solubility by precipitation and increased turbidity, compromised bioavailability, and co-precipitation of other minerals (e.g. zinc, magnesium, calcium and phosphate).

The benefits provided by mineral-fortified liquid compositions are clear, but providing these compositions to consumers presents many problems. Specifically, it is often not desirable or economical to prepare, bottle, ship, store and sell a fortified liquid. One such problem is that the minerals and other nutrients can promote the growth of undesirable bacteria and other microbials. Preservatives can be added to the liquid to slow this gradual contamination problem. However, preservatives add cost and are often viewed by consumers as unnatural and therefore contradictory to the concept of drinking a healthy beverage. Thus, it would be far more desirable if the consumer of such a product could prepare the beverage themselves using their own liquid composition.

Accordingly, there exists a need for a mineral fortification system that allows consumers to prepare a mineral fortified drinking water near to the time and place that the mineral-fortified drinking water is to be consumed. The system should provide the mineral, along with any necessary stabilizing compounds, such as a redox modulating composition, in an easily dispensable form. As such, there is a need for providing a proper bottle in which the mineral-fortified liquid can be delivered and mixed with water in a quick, easy and efficient manner and without extensive exposure to the exterior environment.

U.S. Pat. No. 11,597,669, issued on Mar. 7, 2023 to the present inventor, describes an apparatus for the mineralization of drinking water. This apparatus has a housing with an inlet and an outlet, a filter positioned in the housing, a container receptacle assembly affixed to or formed on the housing, a pump cooperative with the container receptacle assembly, and a manifold connected to an outlet of the pump and to an outlet of the filter. The filter is connected to the inlet of the housing and adapted to filter contaminants. The container receptacle assembly is adapted to connect with a bottle containing a mineral or supplement therein. The pump is adapted to pass the mineral or supplement in a measured amount from the bottle. The manifold is adapted to mix the mineral or supplement with the filtered water so as to discharge a mineralized drinking water through the outlet.

In this prior application to the present inventor, the bottle contains a liquid mineral or supplement therein. In order to properly add the mineral to the filtered water in the manifold, a very small amount of the liquid mineral or supplement should be passed by the pump to the manifold. It has been found that it is extremely difficult to control, with precision, the small amount of liquid mineral or supplement that should be introduced into the manifold. This is particularly the case where peristaltic pumps are used in order to deliver the liquid mineral or supplement to the manifold. Typical peristaltic pumps will generate a certain amount of inertia that causes an imprecise amount of the liquid mineral or supplement to enter the manifold. It is important to be able to deliver the liquid mineral or supplement with precision into the manifold and in very small amounts.

Unfortunately, peristaltic pumps make it exceedingly difficult to deliver a very precise and small amount of the liquid mineral or supplement to the manifold. In order to deliver such a small amount, the peristaltic pump has to be operating at a less-than-optimal speed. This can cause increased wear and tear of the peristaltic pump. Furthermore, the inertial effects associated with such peristaltic pumps can cause an imprecise amount of the liquid mineral or supplement to enter the manifold and mix with the filtered water. Micro-pumps could be used in order to deliver very precise dosings to the manifold. Unfortunately, these micro-pumps are extremely expensive and are often unreliable. As such, a need has developed so as to provide a micro-dosing system using peristaltic pumps that assures that a small, yet precise, amount of the liquid mineral or supplement is introduced into the manifold.

For dosing liquids at comparatively small volumes, various different systems and devices are used. For example, rotary or piston pumps are known in which a defined volume of liquid is sucked into a cylinder and pushed forward by moving piston. However, such pumps apply a comparably high stress to the liquid or the substances in the liquid. This can make these kinds of pumps unsuitable for many applications. For example, proteins are comparably susceptible for surface or mechanical stress such that piston pumps usually are not preferred in applications where proteins part of in the liquid to be dosed.

More gentle dosing can be performed by using a radial peristaltic pump. In such pumps, a flexible tube is arranged along a curved surface of a counter-pressure element. These pumps usually comprise a number of actors or rollers being arranged on a wheel. The rollers are positioned at a distance to the counter-pressure element adjusted such that the flexible tube is compressed when lying between the actor and the counter-pressure element. By turning the wheel, the rollers are moved along the counter-pressure element thereby forwarding a compression of the flexible tube along the counter-pressure element. Together with the compression, an amount of liquid is forwarded inside the flexible tube wherein the volume of forwarded liquid can be defined by the distance between the rollers and the size of the tube. Furthermore, known radial peristaltic pumps often are precise for dosing volumes to as few as 700 microliters. However, in more and more applications, dosages of smaller volumes are desired. As such, the radial peristaltic pumps do not suffice for the reasons described hereinabove.

In the past, various patents have issued with respect to micro-dosing systems. For example, U.S. Pat. No. 3,683,212, issued on Aug. 8, 1972 to S. I. Zoltan, shows a pulsed droplet ejecting system. An electro-acoustic transducer is coupled to liquid in a conduit which terminates in a small orifice. The acoustic impedance of the supply portion of the conduit is large compared with the acoustic impedance of the orifice. The liquid is under small or zero static pressure. Surface tension at the orifice prevents liquid flow when the transducer is not actuated. An electrical pulse with short rise time causes sudden volume changes at the transducer, thereby creating an acoustic pressure pulse having sufficient amplitude to overcome the surface tension at the orifice and eject a small quantity of liquid therefrom. The expelled liquid is replaced by a forward flow of liquid in the conduit under the influence of capillary forces in the orifice.

U.S. Pat. No. 5,593,290, issued on Jan. 14, 1997 to Greisch et al., teaches a micro-dispensing positive displacement pump. This is a multi-chamber pump for dispensing precise volumes of liquids. The pump is especially suited for dispensing volumes in the microliter range. At least three chambers comprising preferably spherical segments are sequentially connected by conduits and are closed by a diaphragm member which is movable into or out of the chambers. The application of pressure or vacuum on one side of the diaphragm draws liquid into the chambers and then expels the liquid from the chambers. Control means are provided for alternating and sequencing the application of pressure and vacuum such that the metered volumes of liquid are pumped from chamber to chamber. Tiny, precisely controlled drops of liquid can be dispensed. A plurality of ganged pumps are also provided in a single pump body to meter independently a plurality of fluids simultaneously. Flows can be joined or split between ganged pumps to provide precise combinations of different fluids.

U.S. Pat. No. 7,900,850, issued on Mar. 8, 2011 to Zenguley et al., provides a micro-dosing apparatus and method for dosed dispensing of liquids. This micro-dosing apparatus includes a fluid conduit having a flexible tube with a first end for connecting to a fluid reservoir and a second end where an outlet opening is located. An actuating device with a displacer with an adjustable stroke is provided, by which the volume of a portion of the flexible tube can be changed to thereby dispense liquid as free flying droplets or as a free flying jet at the outlet opening by moving the displacer between a first end position and a second end position. The tube is partly compressed in the first or the second end positions.

U.S. Pat. No. 9,410,832, issued on Aug. 9, 2016 to Richter et al., provides a microfluidic device for detecting a flow parameter. This microfluidic device includes a channel configured within a base body. The channel includes a first inlet for feeding a first fluid and a second inlet for feeding a second fluid so as to form a fluid stream having the first and second fluids within the channel. It further includes an output for providing the fluid stream on the output side. A first feeder includes a micropump associated with the first inlet for selectively feeding the first fluid to the channel. A second feeder is associated with the second inlet for feeding the second fluid to the channel. A detector detects (on the basis of a different physical property of the first fluid and the second fluid within the channel) a measurement value dependent on a current flow parameter of the first or second fluid.

U.S. Pat. No. 9,459,128, issued on Oct. 4, 2016 to Koltay et al., shows a device and method for dispensing a receiving a liquid volume. This device includes a liquid reservoir having an outlet and a pressure generator which provides a compressible enclosed gas volume of a constant amount of substance with pressure. The gas volume is in direct or indirect fluidic contact with the liquid in the liquid reservoir. A dosing device is coupled to the outlet of the liquid reservoir and operable in order to enable the liquid to pass the outlet. A pressure sensor is arranged to measure a current pressure in the gas volume into output and output signals indicating the current pressure in the gas volume. A controller is coupled to the pressure generator, the dosing device and the pressure sensor.

U.S. Pat. No. 10,928,236, issued on Feb. 23, 2021 to Adler et al., provides a peristaltic dosing device for providing doses of a fluid at a volume of less than one milliliter. This peristaltic dosing device comprises a flexible tube, a counter-pressure element, a plurality of actors and a drive. The flexible tube is straightly arranged along the counter-pressure element thereby forming a longitudinal axis. The actors are arranged parallel to each other along the longitudinal axis. They are movable by the drive in relation to the flexible tube. The flexible tube is compressible between the actors and the counter-pressure elements.

U.S. Pat. No. 11,679,199, issued on Jun. 20, 2023 to Barraud et al., provides a system and method for delivering micro-doses of medication. This device has a wearable pump having a patch-styled form for adhesion to a user's body. The reusable pump may be coupled to a disposable gap housing a micro-dosing system for delivering precise, repeatable doses of medication to a cannula configured to deliver medication to a target infusion area beneath the user's outer skin layer.

U.S. Patent Application Publication No. 2008/0078783, published on Apr. 3, 2008 to M. Helmlinger, teaches a micro-dosing device for a liquid medium that includes a dosing compartment and an electrically or electronically activatable vibration unit which can cause at least one contact area of the dosing compartment to vibrate for the delivery of a volume of the liquid medium. A medium reservoir is connected to the dosing compartment by at least one flow channel. A manually-operable conveyance device conveys the medium to the dosing department or conveys the medium back from the dosing compartment to the medium reservoir and is assigned to the at least one flow channel.

It is an object of the present invention to provide a micro-dosing apparatus for a water mineralization system that allows a peristaltic pump to deliver microdoses of liquid mineral or supplements.

It is another object of the present invention to provide a micro-dosing apparatus for water mineralization system that avoids the use of micro-pumps.

It is another object of the present invention to provide a micro-dosing apparatus for water mineralization system that avoids the effects of inertia from the peristaltic pump.

It is another object of the present invention to provide a micro-dosing apparatus for a water mineralization system that allows the pump to operate at high speeds.

It is another object of the present invention to provide a micro-dosing apparatus for a water mineralization system that allows the dispensing of liquids at relatively high pressures.

It is another object of the present invention to provide a micro-dosing apparatus for a water mineralization system that avoids flashing during dispensing.

It is a further object of the present invention to provide a micro-dosing apparatus for water mineralization system that achieves a consistent flow.

It is another object of the present invention to provide a micro-dosing apparatus for water mineralization system that enhances the life of the pump.

It is still a further object to the present invention to provide a micro-dosing apparatus for a water mineralization system that allows the pump to operate at optimal speeds.

These and other objects and advantages of the present invention will become apparent from a reading of the attached specification and appended claims.

### BRIEF SUMMARY OF THE INVENTION

The present invention is a micro-dosing system for a water mineralization process, the micro-dosing system comprises a bottle having a liquid mineral or supplement therein, a cap affixed to an opening of the neck of the bottle, a pump connected to a channel of the cap, and a splitter connected to the pump and with the channel of the cap. The bottle has an opening and a neck extending therefrom. The neck opens to an interior volume of the bottle. The cap has the channel formed through the cap. The channel communicates with the interior volume of the bottle. The cap has a return passage formed therein. The return passage communicates with the internal volume of the bottle. The pump is adapted to draw the liquid mineral or supplement through the channel. The splitter has an outlet formed thereon. The outlet passes a portion of the liquid mineral or supplement from the channel of the cap. The splitter has a return line communicating with the return passage of the cap. The return line is adapted to pass a remainder of the liquid mineral or supplement back through the return passage of the cap and into the interior volume of the bottle.

The channel of the cap has a straw extending therefrom and into the interior volume of the bottle. The return passage is annular and surrounds the channel of the cap. The cap has an upper surface extending across the opening of the neck of the bottle. The cap has an annular portion connected to the upper surface. This annular portion bears against an inner wall of the neck of the bottle. The cap has a tubular portion extending downwardly therefrom. The tubular portion receives the straw therein. The straw extends into the interior volume of the bottle.

In the preferred embodiment of the present invention, the pump is a peristaltic pump. The pump causes of the liquid mineral or supplement to flow through the channel of the cap, through an inlet of the splitter, through the return line of the splitter, and into the return passage of the cap. The outlet of the splitter is fed by a line extending from an inlet of the splitter. The line has a diameter that is a fraction of the diameter of the inlet of the splitter. In the preferred embodiment of the present invention, this fraction will be approximately one-tenth.

The splitter has a chamber disposed between an inlet and the outlet thereof. The outlet of the splitter has a line opening to the chamber. The line has a diameter that is a fraction of the diameter of the inlet of the splitter. A circuitous path is formed in the chamber of the splitter. The liquid mineral or supplement flows along the circuitous path prior to entering the line to the outlet of the splitter. The first hose is connected the channel of the cap and to the inlet of the pump. A second hose is connected to an outlet of the pump and to an inlet of the splitter. A third hose is connected to the return line of the splitter and to the return passage of the cap.

The present invention is also water filtering and mineralization apparatus that comprises a system adapted to filter and mineralize water. The system has a container receptacle assembly formed or affixed thereto. The system has a manifold for receiving filtered water and a liquid mineral or supplement therein and to mix the filtered water with the liquid mineral or supplement. A bottle is received by the container receptacle assembly. The bottle has the liquid mineral or supplement therein. The bottle has an opening in a neck extending therefrom. This neck opens to an interior volume of the bottle. A cap is affixed to the opening of the neck of the bottle. This cap has a channel formed through the cap. The channel communicates with the interior volume of the bottle. The cap has a return passage formed therein. The return passage communicates with the interior volume of the bottle. A pump is positioned adjacent to the container receptacle assembly of the system. This pump is connected to the channel of the cap. The pump is adapted to draw the liquid mineral or supplement through the channel. A splitter is connected to the pump and with the channel of the cap. The splitter has an outlet adapted to pass a portion of the liquid mineral or supplement from the channel of the cap into the manifold of the system so as to mix the liquid mineral or supplement with the filtered water therein. The splitter has a return line communicating with the return passage of the cap. The return line is adapted to pass a remainder of the liquid mineral or supplement back through the return passage of the cap and into the interior volume of the bottle.

The water filtering and mineralization apparatus of the present invention utilizes a peristaltic pump. The outlet of the splitter is fed by line extending from an inlet of the splitter. This line has a diameter that is fraction of the diameter of the inlet of the splitter. The splitter has a chamber disposed between the inlet and the outlet thereof. The outlet of the splitter has a line opening to the chamber. The line has a diameter that is a fraction of a diameter of the inlet of the splitter. A circuitous path is formed in the chamber of the splitter. A liquid mineral or supplement flows along the circuitous path prior to entering the line to the outlet of the splitter.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is an upper perspective view of a bottle that contains a liquid mineral or supplement in accordance with the teachings of the present invention.

FIG. 2 is a cross-sectional view of the bottle in accordance as used within the teachings of the present invention.

FIG. 3 is a plan view of the cap is used on the bottle of the water mineralization system of the present invention.

FIG. 4 is a cross-sectional view of the cap as used on the bottle of the water mineralization system of the present invention.

FIG. 5 is an upper perspective view of the water mineralization system as used in association with the micro-dosing system of the present invention.

FIG. 6 is a frontal view of the water mineralization system is used in association with the micro-dosing system of the present invention. In particular, the water mineralization system has the covers removed therefrom in FIG. 6.

FIG. 7 is an upper perspective view of the water mineralization system as used in association with the micro-dosing system of the present invention showing the interior of the housing and the equipment within the interior of the housing.

FIG. 8 is an upper perspective view showing the water treatment components and micro-dosing system associated with the water mineralization system of the present invention.

FIG. 9 is an upper perspective close-up view of the container receptacle assembly as used in association with the liquid mineral or supplement-containing bottle of the present invention.

FIG. 11 is a cross-sectional view showing the micro-dosing system as used in the water mineralization system of the present invention.

FIG. 12 is a detailed cross-sectional view showing the micro-dosing system for the water mineralization system of the present invention.

FIG. 13 is an exploded view showing the splitter as used in the micro-dosing system of the present invention.

FIG. 14 is a frontal view showing the chamber of the splitter of the micro-dosing system of the present invention.

### DETAILED DESCRIPTION OF THE INVENTION

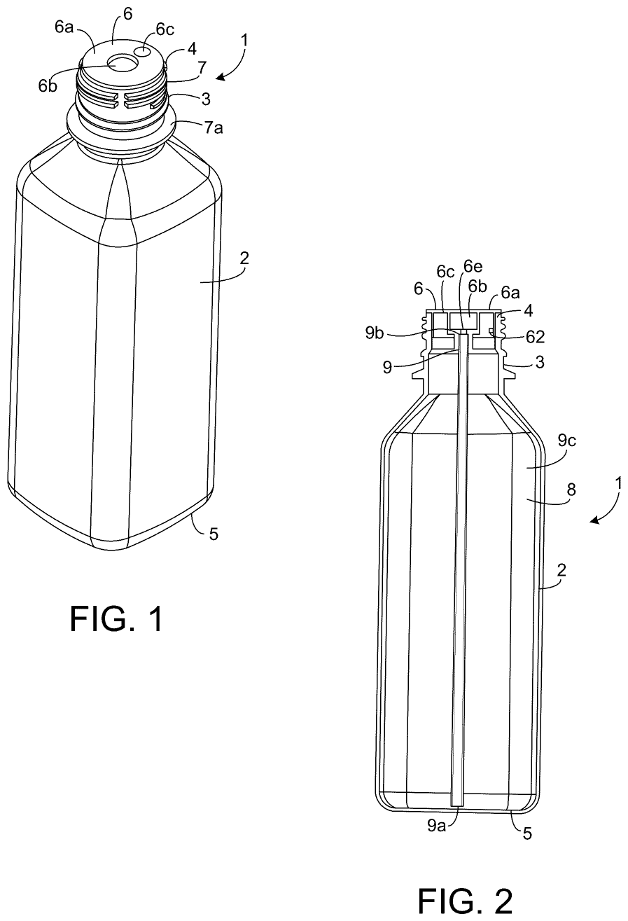

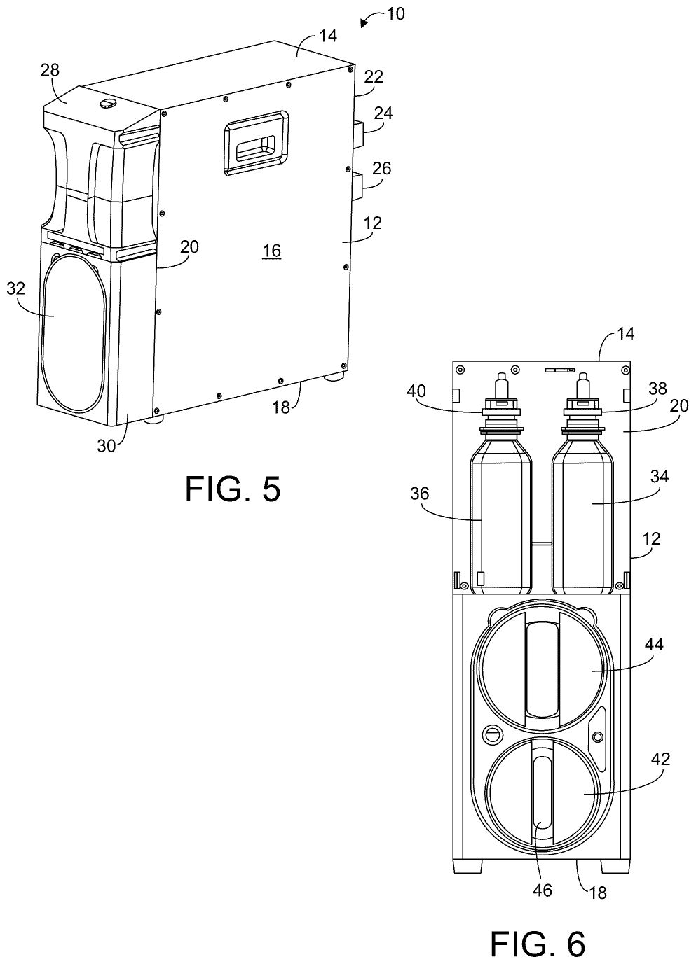

Referring to FIG. 1, there is shown the bottle 1 for use in the micro-dosing system for the mineralization of drinking water (as shown in FIGS. 5-9 herein). This bottle is adapted to be connected to the micro-dosing system of the present invention so that a precise and controlled small amount of the liquid mineral or supplement can be delivered for mixing in a manifold of the water mineralization system. The bottle 1 comprises a body 2 having neck 3 extending outwardly therefrom. The neck 3 defines an opening at an upper end of the body 2. The body 2 has an interior volume and a bottom 5.

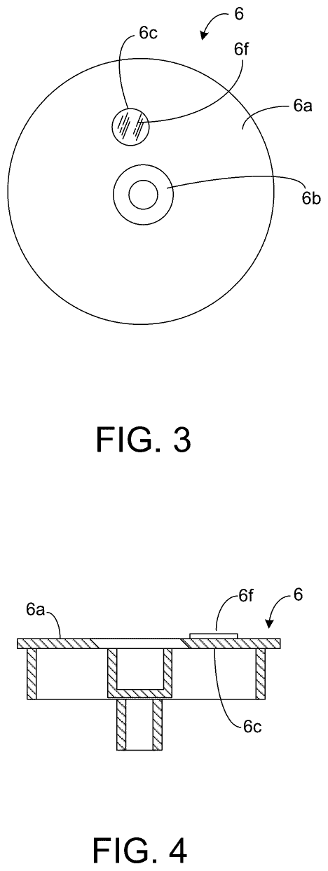

An inner cap 6 is fixedly positioned on the opening 4 of the body 2. The inner cap 6 has an upper surface 6a affixed over the opening 4 of the body 2. The inner cap 6 has a receptacle 6b opening at the upper surface 6a. A hole 6c is also formed in the upper surface 6a of the inner cap 6. Hole 6c opens to the interior volume of the body 2. The hole 6c will have an air-transmissive material affixed thereover or therein. This air-transmissive material is shown, in greater detail, in association with FIGS. 3 and 4. The air-transmissive material within the hole 6c allows air to enter the interior the bottle 1 while, at same time, preventing pathogens and particles from entering the interior of the bottle.

FIG. 1 shows that the neck 3 has threads 7 formed on the outer diameter thereof.

Threads 7 are adapted to receive an outer cap. The outer cap (not shown) can be threadedly and releasably engaged with the threads 7 so as to seal the receptacle 6b and the hole 6c during transport and storage of the bottle 1. The cap can be removed so as to expose these elements. There is a ridge 7a extending outwardly of neck 3. As will be described hereinafter, the ridge 7a is adapted to be received by a lower yoke of a bracket associated with the water mineralization system.

FIG. 2 is a cross-sectional view of the bottle 1. In particular, bottle 1 is illustrated as having a body 2 and an interior volume 8. The neck 3 is formed at the upper end of the bottle 1 and extends from the body 2. The inner cap 6 is placed over the opening 4 at the upper end of the neck 3. The inner cap 6 has an upper surface 6a that is affixed over the opening 4 of the bottle 1. The inner cap 6 has an annular portion 6d extending downwardly from the upper surface 6a. This annular surface 6d bears against an inner wall of the neck 3 of the body 2. The inner cap 6 has receptacle 6b opening at the upper surface 6a. The inner cap 6 has a channel 6e extending downwardly therefrom so as to open to the interior volume 8 of the body 2. The hole 6c is formed in the upper surface 6a and extends therethrough so as to open to the interior volume 8 of the body 2. As such, any suction created during the drawing of the mineral or supplement-containing liquid 9c through end 9a will be equalized by the air passing through the air-transmissive material of the hole 6c. As such, this effectively prevents pathogens and particles from entering the interior volume 8 of the bottle 1 while, at the same time, allowing pressures to be equalized within the interior volume of the bottle 1. The hole 6c is positioned adjacent to the receptacle 6b.

A straw 9 extends to the channel 6e and into the interior volume 8 of the body 2. The straw 9 has an end 9a positioned in proximity to the bottom 5 of the body 2. The straw 9 has an upper end 9b opening at the receptacle 6e.

With reference to FIG. 1 and in relation to later descriptions of the bottle 1, it should be noted that the hole 6c is formed through the upper surface 6a of the inner cap 6. This hole has an air filter material covering the hole 6c at the upper surface 6a of the inner cap 6. This air filter material is adapted to allow air flow into the interior volume of the bottle and to block airborne contaminants from entering the interior volume 8 of the bottle 1. The hole 6c can also have the air filter material positioned on an interior of the hole.

The inner cap 6 is formed of an elastomeric material. The bottle 1 is formed of a glass material. The thread 7 and the ridge 7a extend outwardly of the outer diameter of the neck 3. A mineral or supplement-containing liquid 9c received in the interior volume 8 of the bottle 1.

FIG. 3 shows the inner cap 6. In particular, the upper surface 6a is particularly illustrated. The receptacle 6b is illustrated as opening at this upper surface 6a. The hole 6c is positioned adjacent to the receptacle 6b. The air-transmissive material 6f is illustrated, in FIG. 3, as affixed within the hole 6c. The air-transmissive material is an N95 material. This N95 material is formed of non-woven polypropylene and adapted to prevent pathogens or particles from entering the interior volume of the bottle 1.

FIG. 4 is a cross-sectional view of the inner cap 6 and particularly shows the hole 6c having the air-transmissive material 6f affixed to the top surface 6a so as to cover the hole 6c. As such, the N95 material of the air-transmissive material 6f prevents pathogens or particles from flowing therethrough and through the hole 6c into the interior volume of the bottle 1.

Referring to FIG. 5, there shown a water mineralization system 10 as used with the bottle and cap of the present invention. The water mineralization system 10 includes a housing 12 having a generally rectangular cubicle configuration. In particular, housing 12 has upper surface 14, side wall 16, bottom 18, front wall 20 and back wall 22. Walls 14, 16, 18 and 20 enclose the assembly for the treatment of water. In particular, in FIG. 5, the back wall 22 includes an inlet connection 24. Inlet connection 24 is adapted to allow tap water to be introduced into the interior of the housing 12. A support 26 is illustrated below the inlet 24. Support 26 is configured so as to support a line extending for the introduction of tap water into the housing 12. An outlet for the mineralized drinking water is positioned on a side of the inlet 24 (not shown in FIG. 5).

In FIG. 5, it can be seen that there is a first cover 28 that is positioned against the front wall 20 of the housing 12. This first cover 28 extends over the mineral or supplement-containing bottles 1 used in the dosing of minerals into the drinking water. Cover 28 is removably positioned adjacent to the upper surface 14 of the housing 12. A second cover 30 is positioned against the front wall 20 of the housing 12 and extends so as to be positioned generally adjacent to the bottom 18 of the container 12. Second cover 30 is intended to removably cover the filters contained within the housing 12. In particular, second cover 30 can include a flap or surface 32 that can be removed from the cover 30 so as to allow direct access to the filters within the housing 12.

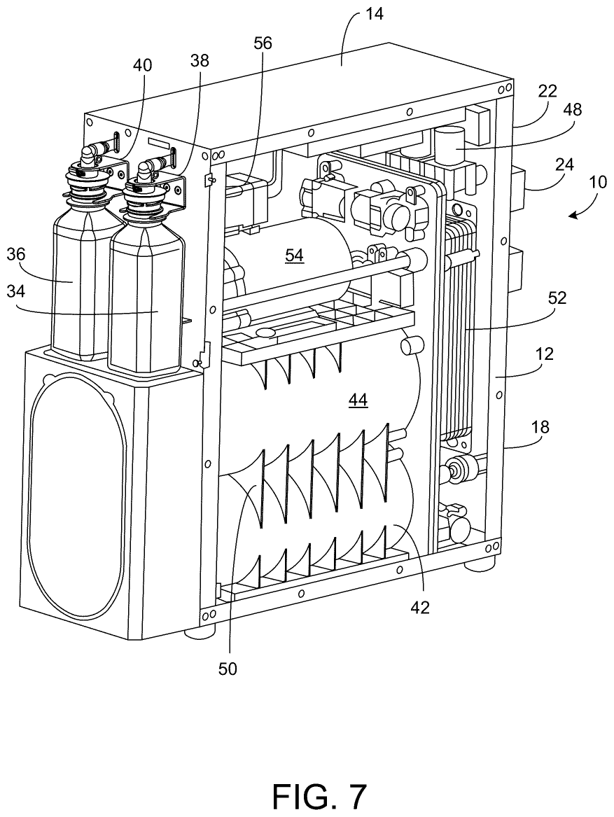

FIG. 6 shows the configuration at the front wall 20 of the housing 12. In FIG. 6, it can be seen that there is a first bottle 34 and a second bottle 36 that are positioned adjacent to the top 14 of housing 12. These bottles 34 and 36 have a configuration identical to that shown by bottle 1 in FIGS. 1 and 2. Each of the bottles 34 and 36 are connected to container receptacle assemblies 38 and 40. The container receptacle assemblies 38 and 40 have a unique configuration which is described in greater detail herein in association with FIGS. 7-9. The bottles 34 and 36 are removably connected respectively to the container receptacle assemblies 38 and 40. The bottles 34 and 36 can contain minerals and/or supplements therein. In particular, one of the bottles can contain one type of mineral and the other bottle can contain another type of mineral. As such, through a control system, the filtered drinking water can be dosed with a desired quantity of the minerals or supplements from bottle 34 and a desired quantity of the minerals or supplements from bottle 36. If necessary, the control system can be actuated so as to prevent any of the minerals in either of the bottles 34 and 36 from entering the system. The controls can also be adapted to control the rate at which the minerals pass from the bottles 34 and 36 into the filtered water within the interior of the housing 12.

FIG. 6 shows the front wall 20 of the housing 12 with the second cover 30 removed. The removal of the second cover 30 exposes a first filter 42 and a second filter 44. The end of the first filter 42 is exposed at the front wall 20 so that the handle 46 of first filter 42 can be accessed. As such, if it is desired to remove or repair the first filter 42, it is only necessary to remove the cover 30 (or flap 32), access the handle 46, rotate the handle 46 and slide the first filter 42 out of position. A similar action can occur with respect to the second filter 44.

The first filter 42 is a pretreatment filter or a carbon filter. The second filter 44 is a reverse osmosis filter. When the first filter 42 is a pretreatment filter, the tap water entering the inlet 24 of the housing 12 will flow in this pretreatment filter so that the pretreatment filter can provide an initial treatment to the water and remove sediment and other contaminants therefrom. The water will flow from the pretreatment filter 42 into the reverse osmosis filter 44 for further removal of any metals, chemicals, contaminants or ions from the water. Importantly, each of the first filter 42 and second filter 44 is located adjacent to the bottom 18 of the housing 12. The first filter 42 and the second filter 44 are also located below the bottles 34 and 36 and located below the container receptacle assemblies 38 and 40. This arrangement greatly improves efficiency in terms of the management of the filters and the bottles. The ease of accessibility of the filters 42 and 44 greatly improves efficiency in the water treatment process and the repair or replacement of the filters.

FIG. 7 further shows the water mineralization system 10 as used with the bottle of the present invention. In particular, FIG. 7 shows that the inlet 24 at the back wall 22 of housing 12 has a valve 48 associated therewith. Valve 48 is movable between an open position and a closed position. In the closed position, tap water flow into the interior of housing 12 is blocked. In the open position, tap water flow into the interior of the housing 12 is permitted. The valve 48 is easily accessible so as to allow water flow to be immediately turned off in the event that leaks should occur or in the event that leak detection equipment within the interior of the housing 12 should signal a leak. This avoids the need to locate the source of the water flow in order to stop the water flow to the water mineralization system 10.

In FIG. 7, it can be seen that the first filter 42 and the second filter 44 extend longitudinally across the housing 12. Various brackets 50 support these filters in their desired position. A manifold 52 is illustrated as positioned adjacent to the back wall 18 of the housing 12. Manifold 52 extends in a generally vertical orientation. The manifold 52 is positioned between the first and second filters 42 and 44 and the back wall 18. Manifold 52, as will be explained hereinafter, serves to receive the flow of the mineral or supplement-containing liquid as pumped from the bottles 34 and 36 and mixes this mineral-containing liquid in the manifold 52 with the filtered water from the first and second filters 42 and 44.

Since it is necessary to pressurize the pre-treated water in order to have the pretreatment water flow through the reverse osmosis filter 44, a diaphragm pump 54 is positioned in the interior of housing 12. Diaphragm pump 54 will receive the pretreated water from the first filter 42, pressurize the water, and then pass the water, under pressure, through the second filter 44 (the reverse osmosis filter). The filtrate from the second filter 44 can then flow into the manifold 52 for the purposes of mixing the minerals with the demineralized water.

It is very important to control the rate and amount of the mineral or supplement-containing liquid from the bottles 34 and 36 that enters the filtered water. As such, a peristaltic pump 56 is used in association with each of the bottles 34 and 36. Peristaltic pump 56 operates in a conventional manner so as to assure the delivery of a desired quantity or rate of mineral-containing liquid to the manifold 52. Peristaltic pumps, as they are known, utilize flexible tubes and rollers so as to pass a fixed amount of fluid flow. The peristaltic pump 56 avoids the use of any valves. Suitable servomotors can be utilized in conjunction with the peristaltic pump 56 so as to control the rate at which the mineral-containing liquid is discharged into the manifold 52. Since the peristaltic pump 56 is used for drawing the liquid from the bottles 34 and 36, it is very important that the hole with its air-transmissive material (as shown in FIGS. 3 and 4) be used in association with the bottles 34 and 36. Ultimately, the pressures that are generated by the peristaltic pump 56 could collapse the walls of the bottles 34 and 36 if the mineral-containing liquid within the bottles starts to empty. This pressure could also cause the polymeric cap to be displaced from the neck of the bottle and into the interior volume of the bottle. As such, the bottle would be rendered unusable for future use. The use of the hole and the air-transmissive material serves to equalize pressures within the interior of the bottle when the liquid starts to empty from the bottle. As such, damage to the bottle and to the cap is effectively prevented while, at the same time, preventing pathogens and particles from entering the interior of the bottle.

FIG. 7 further shows that the water mineralization system 10 has special container receptacle assemblies 38 and 40 positioned adjacent to the top 14 of housing 12. Peristaltic pump 56 is positioned on the interior of housing 12 and adjacent to these container receptacle assemblies 38. The close positioning of the peristaltic pump 56 to the container receptacle assemblies 38 and 40 assures the proper operation of the peristaltic pump and the proper delivery of fluid from the bottles 34 and 36. If the peristaltic pump 56 were not positioned adjacent to the container receptacle assemblies 38 and 40, there could be more dosing error associated with the delivery of the mineral-containing liquid from the bottles 34 and 36.

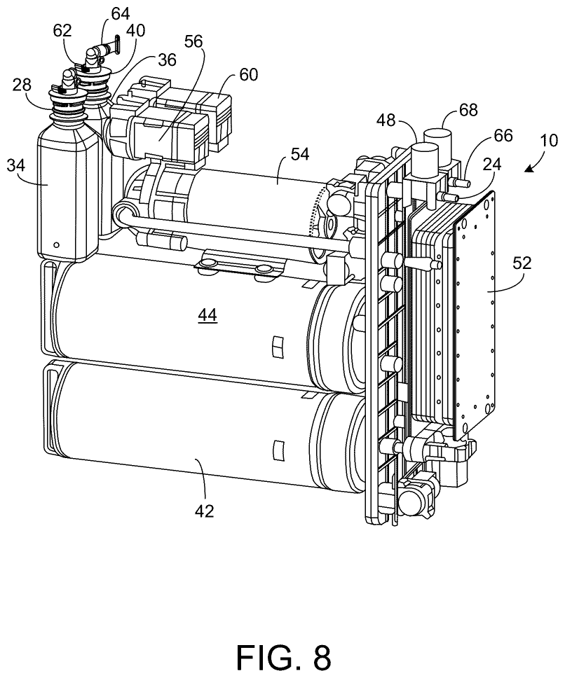

FIG. 8 shows the interior of the water mineralization system 10 as used with the bottle of the present invention. In particular, FIG. 8 shows the first filter 42 and the second filter 44 arranged one on top of another adjacent to the bottom of the housing. Bottles 34 and 36 are positioned adjacent to the top of the housing. The peristaltic pump 56 is positioned adjacent to the container receptacle assembly 38. Peristaltic pump 60 is positioned adjacent to the container receptacle assembly 40. A line or conduit will extend from the elbows 62 and 64 of the respective container receptacle assemblies 38 and 40 to the respective peristaltic pumps 56 and 60.

FIG. 8 shows the configuration of the inlet 24 and the outlet 66. Inlet 24 receives the tap water into the interior of the housing. Outlet 66 allows for the discharge of mineralized drinking water from the housing. Valve 48 extends outwardly from the inlet 24 and operates to control the flow of water through the inlet 24. Valve 68 is associated with the outlet 66 and can control the flow of mineralized drinking water out of the outlet 66. Initially, the tap water will flow through the inlet 24 and down to the first filter 42 for pretreatment purposes. The outlet of the first filter 42 will flow to the diaphragm pump 54 for pressurization prior to passing to the second filter 44 (the reverse osmosis filter). Ultimately, the filtered water from the reverse osmosis filter 44 will be devoid of minerals. It can then flow into the manifold 52 for mixing with a mineral-containing liquid from bottles 34 and 36. After mixing, the manifold 52 will then pass the flow of the mineralized drinking water to the outlet 66. The manifold 52 can be connected to the outlet 66 of the housing 12 or it can be the outlet of the housing 12.

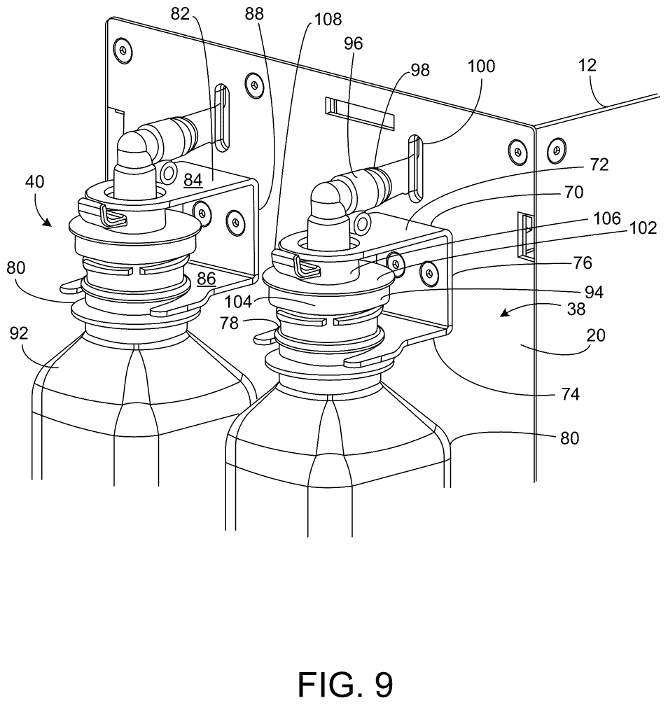

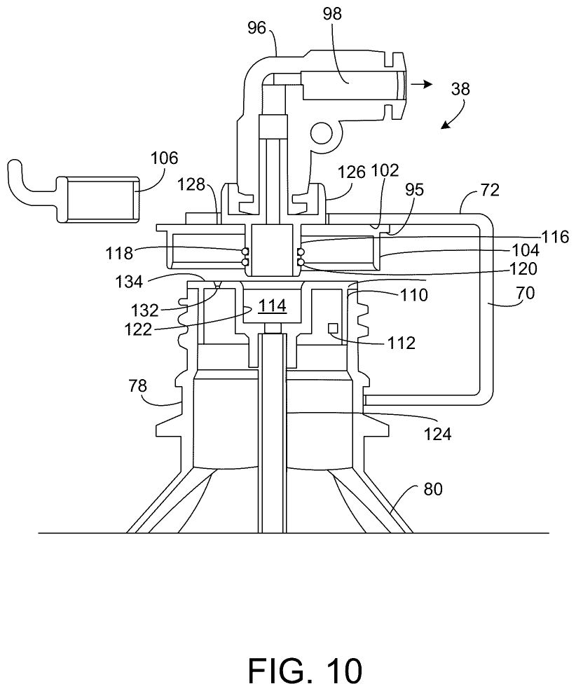

FIG. 9 is a detailed view showing the container receptacle assemblies 38 and 40 that receive the bottles of the present invention. It can be seen that the container receptacle assemblies 38 and 40 are mounted to the front wall 20 of housing 12. In particular, the container receptacle assembly 38 has a bracket 70 affixed to the front wall 20 of housing 12. Bracket 70 defines an upper yoke 72 and a lower yoke 74. Upper yoke 72 is in parallel planar relationship to the lower yoke 74. The central portion 76 of the bracket 70 is screwed or bolted to the front wall 20 of the housing 12. It can be seen that the lower yoke 74 is adapted to engage with the neck 78 of bottle 80.

Similarly, the second container receptacle assembly 40 includes bracket 82 affixed to the front wall 20 of housing 12 in side-by-side relationship to the first bracket 70. Once again, the bracket 82 includes an upper yoke 84 and a lower yoke 86 in parallel planar relationship. A central portion 88 is bolted or screwed to the front wall 20 of housing 12. The lower yoke 86 is adapted to receive the neck 90 of bottle 92. The second container receptacle 40 will identical configuration to that of the first container receptacle assembly 38. As such, the description associated hereinafter in association with a first container receptacle assembly 38 applies to the second container receptacle assembly 40.

In FIG. 9, there is an outer cap 94 that extends over the top of the neck 78 of bottle 80. A conduit 96 in the pipe elbow 98 is connected to an upper portion of the outer cap 94 (not shown). The conduit 96 will extend through slot 100 in the front wall 20 of housing 12. It can be seen that the slot 100 has a length which is greater than the diameter of the conduit 96. As such, this provides for a certain amount of “play” during the lifting and lowering of the elbow 98 and the outer cap 94. The upper yoke 72 is adapted to limit an upward travel of the outer 94. The conduit 96 will communicate with the peristaltic pump 56.

The outer cap 94 has a generally planar upper surface 102 and an annular portion 104 extending downwardly from the generally planar upper surface 102. The generally planar upper surface is adapted to be releasably positioned adjacent an opening of the bottle 80. The annular portion 104 surrounds a portion of the neck 78 of the bottle 80. As will be described hereinafter, the outer cap 94 has a nipple (not shown) that extends downwardly from the generally planar upper surface 102. This nipple is adapted to engage with an opening of the bottle 80 so as to draw a portion of the mineral or supplement from the bottle 80. The nipple will be connected to the conduit 96. A clip 106 is removably affixed over an upper portion of the outer cap 98. This clip 106 is interposed between the generally planar upper surface 102 of the outer cap 94 and an underside of the upper yoke 72 of the bracket 70 when the outer cap 94 is positioned over the bottle 80. Clip 106 has an arm 108 extending therefrom. As such, it can be easily inserted or removed over an upper portion of the outer cap 94. The introduction of this clip 106 assures that the upper cap 94 remains in its desired position and that the connections in the interior of the outer cap 94 remain intact, even during the vibration of equipment associated with the system of the present invention.

FIG. 10 is a cross-sectional view of the container receptacle assembly 38. A similar construction is associated with the container receptacle assembly 40. In FIG. 10, the bottle 80 has a neck 78 extending upwardly therefrom. The bottle 80 has an opening 110 at the upper end thereof. An inner cap 112 is received in the opening 110 of the bottle 80. This inner cap 112 has a receptacle 114 therein. The receptacle 114 releasably receives the nipple 116 of the outer cap 94. The receptacle 114 is circular. Similarly, the nipple 116 has an annular configuration. As such, O-rings seals 118 and 120 are received in notches formed on the nipple 116. O-rings seals 118 and 120 will engage in a liquid-tight manner with the inner wall 122 of the receptacle 114. This assures a liquid-tight connection between the outer cap 94 and the inner cap 112. The receptacle 114 has a straw 124 extending into the bottle 80. Straw 124 can extend all the way to the bottom of the bottle 80 so as to continue to draw the mineral or supplement-containing liquid from the interior of the bottle 80. The suction exerted by the peristaltic pump 56 will act on the conduit 96 of the pipe elbow 98. As such, the suction force will be drawn through the conduit 98. The suction force (illustrated by the arrow in FIG. 10) is adapted to draw the liquid from the interior of bottle 80 when the nipple 116 is engaged with the receptacle 114.

FIG. 10 illustrates that the outer cap 94 has a generally planar upper surface 102 and an annular portion 104 extending downwardly therefrom. Outer cap 94 also has an upper portion 126 engaged with a convention quick connect/disconnect coupling with the pipe elbow 96. There is an opening 128 formed in the upper yoke 72 of bracket 70 through which this upper portion 126 extends. The upper portion 126 can move up and down freely through this opening 128. The clip 106 is illustrated as having been removed from the space between the outer cap 94 and the inner cap 12.

In FIG. 10, there is shown that the upper surface 130 of the inner cap 112 has a hole 132 formed therethrough. Hole 132 is a vacuum-breaking air passage. As such, the open air flow will avoid any vacuum locks that could otherwise occur within the interior of the bottle 80. Importantly, an air filter material 134 is positioned over the hole 132 or into the hole 152. This air filter material 134 can be in the nature of N95 facemask material. As such, it filters 95% of airborne bacteria. Ultimately, the air filter material 134 blocks airborne contaminants from entering the interior of the bottle 80 while allowing airflow through the hole 132. The air filter material 134 will further assure that there is enough space between the outer cap 94 and the inner cap 112 so as to allow airflow therebetween.

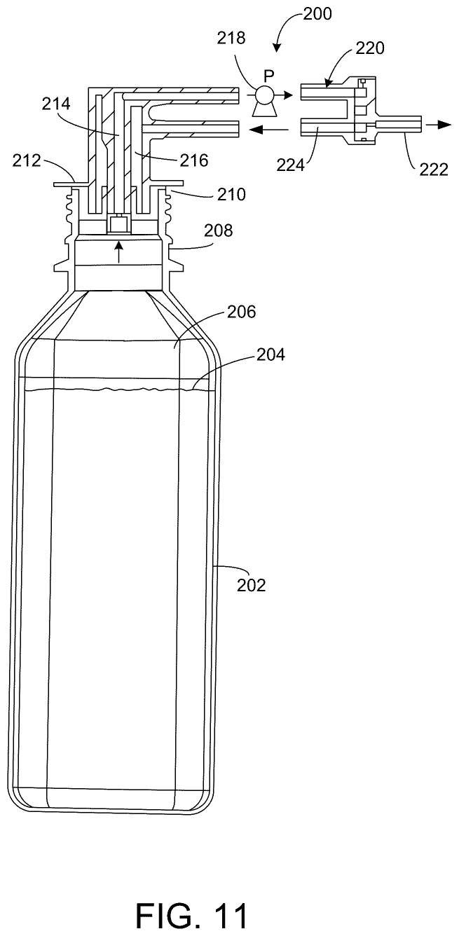

FIG. 11 shows the micro 1 dosing system 200 as used with the water mineralization system shown in the previous FIGS. 1-10. In particular, the micro-dosing system 200 includes a bottle 202 having a liquid or mineral supplement 204 within an interior volume 206 of the bottle 202. The bottle has a neck 208 with an opening 210 formed in the neck 208. The opening 210 opens to the interior volume 206 of the bottle 202. A cap 212 is affixed to the opening 210 of the neck 208 of the bottle 202. Cap 212 has a channel 214 formed through the cap 212. Channel 214 communicates with the interior volume 206 of the bottle 202. The cap 212 has a return passage 216 formed therein. The return passage communicates with the interior volume 206 of the bottle 202. A pump 218 is connected to the channel 214 of the cap 212. Pump 218 is adapted to draw the liquid mineral or supplement 204 through the channel 214. A splitter 220 is connected to the pump 218 and with the channel 214 of the cap 212. The splitter 220 has an outlet 222 formed thereon. This outlet 222 passes a portion of the liquid mineral or supplement 204 from the channel 214 of the cap 212. The splitter 220 has a return line 224 communicating with the return passage 216 of the cap 212. The return line 224 is adapted to pass the remainder of the liquid mineral or supplement 204 back through the return passage 216 of the cap 212 and into the interior volume 206 of the bottle 202. The channel 214 of the cap 212 will have a straw (such as straw 9 shown in FIG. 2) extending therefrom and into the interior volume 206 of the bottle 202. FIG. 11 shows that the return passage 216 is annular and surrounds the channel 214 of the cap 212.

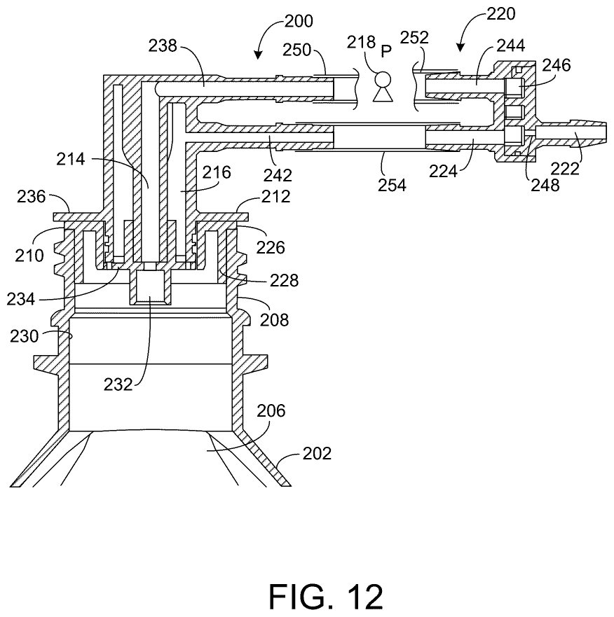

FIG. 12 is a more detailed view showing the micro-dosing system 200 of the present invention. In particular, FIG. 12 shows the neck 208 of the bottle 202. The cap 212 will have an upper surface 226 that extends across the opening 210 of the bottle 202. The cap 212 also has an annular portion 228 that is connected to the upper surface 226 and bears against an inner wall 230 of the neck 208 of the bottle 202.

FIG. 12 shows, in particular, that there is a tubular portion 232 that extends from a wall 234 of the cap 212. Tubular portion 232 is adapted to receive an upper end of the straw. Tubular portion 232 extends into the interior volume 206 within the neck 208 of the bottle 202. The cap 212 includes an overlying portion 236 that will bear against the upper surface 226 and across the opening 210 of the neck 208 of bottle 202. The channel 214 is illustrated as extending to and communicating with the interior of the tubular portion 232 and ultimately with the straw within the interior volume 206 of the bottle 202. As such, a channel 214 is adapted to allow the liquid mineral or supplement 204 to pass therethrough. Ultimately, channel 214 has a conduit 238 extending to the pump 218. Pump 218 is a peristaltic pump (as illustrated herein previously). Pump 218 draws the liquid mineral or supplement from the interior volume 206 of the bottle 202, through the tubular portion 232, through the channel 214 and through the conduit 238.

In FIG. 12, it can be seen that the return passage 216 is of an annular nature and surrounds the channel 214. Ultimately, the return passage 216 will communicate through the wall 234 with the interior volume 206 of the bottle 202. As such, as the remainder of the liquid mineral or supplement flows through the line 242 and into the return passage 216, it will flow back into the interior volume 206 of the bottle 202.

The force of the pump 214 will continue to draw the liquid toward the splitter 220. Splitter 220 is connected to the pump 218 and ultimately with the channel 214 of the cap 212. The splitter 220 has an outlet 222 formed thereon. This outlet 222 passes a portion of the liquid mineral or supplement 204 from the channel 214 of the cap 212. The splitter 222 has a return line 224 communicating with the return passage 216 of the cap 212. The return line 224 is adapted to pass remainder of the liquid mineral or supplement back to the return passage 216 of the cap 212 and into the interior volume 206 of the bottle 202. The splitter 220 also has an inlet 244 which extends to a chamber 246 formed in an interior thereof. Chamber 246 communicates with the outlet 222 by way of a line 248. It can be seen that line 248 has a diameter which is merely a fraction of the diameter of the inlet 244 and/or a fraction of the diameter of the outlet 222. Ultimately, the inlet 244 will communicate with the return line 224 through the chamber 246 (in the manner described hereinafter).

A first hose 250 will connect the conduit 238 (connected to the channel 214) with the pump 218. A second hose 252 connects an outlet of the pump 218 with the inlet 244 of the splitter 220. A third hose 254 connects the return line 224 with the return passage 216 of the cap 212.

In normal use, the peristaltic pump 216 will draw a relatively large amount of the liquid mineral or supplement 204 through the channel 214, through the conduit 238 and into the inlet 244 of the splitter 220. This relatively large amount of the liquid mineral or supplement will reside, for short time, within the chamber 246. The line 248 will deliver a small portion (i.e. a micro-dose) of this liquid mineral or supplement into the outlet 222. The remainder of the liquid mineral or supplement from the chamber 246 will then flow outwardly of the splitter 220 by way of the return line 222, through the third hose 254, through the line 242 and into the return passage 216 of the cap 212. In this manner, the relatively large amount of the liquid mineral or supplement that flows by virtue of the action of the peristaltic pump 218 can be delivered as micro-doses from the outlet 222 into the manifold (described herein previously) of the water mineralization system. The remainder is delivered back into the interior volume 206 of the bottle 202. The peristaltic pump 218 can operate at its optimal speed and it can also operate at relatively high speeds. This minimizes the wear-and-tear on the peristaltic pump and allows the peristaltic pump to operate within optimal limits. The small line 248 assures that only a very small and measured quantity of the liquid delivered by the peristaltic pump 218 will enter the manifold. As such, a regular and constant supply of the liquid mineral or supplement can be delivered consistently to the manifold.

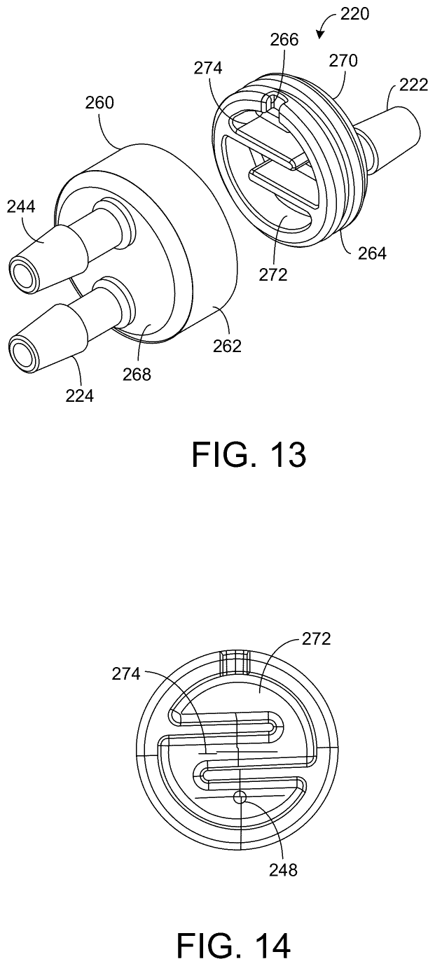

FIG. 13 shows an exploded view of the splitter 220. It can be seen that the splitter 220 has a body 216 that includes a first portion 262 and a second portion 264. First portion 262 is fitted onto the second portion 262. A key element can be received within the slot 266 formed on the second portion 264 of the body 260. The inlet 244 extends outwardly of a face 268 of the first portion 262 of the body 260. The return line 224 also extends outwardly of the face 268 of the first portion 262 of the body 260. The inlet 244 can be in generally spaced parallel relationship with the return line 224. The outlet 222 extends outwardly of a face 270 of the second portion 264 of the body 260. The second portion 264 of the body 260 defines a chamber 272 having a convoluted or circuitous pathway 274 therein. As the liquid mineral or supplement enters through the inlet 244, it enters the chamber 272 and flows along the circuitous path 274 and ultimately into the outlet 222. It will then flow from the circuitous path 274 back toward the return line 222.

FIG. 14 shows a detailed view of this chamber 272, along with the circuitous path 274. The line 248 is illustrated as opening to the circuitous path 274 within the chamber 272. This relatively small diameter line 248 can then flow into the outlet 222. The use of the chamber 272 along with the circuitous path 274 enhances the ability to provide a consistent flow of the liquid mineral or supplement toward the line 248 and, ultimately, to the outlet 222. This avoids any possible flashing of the liquid at this area. The relatively small output of the line 248 toward the outlet 228 avoids any problems associated with any inertia of the peristaltic pump. This configuration avoids any possible locking of the peristaltic pump at slow speeds. Only a fraction of the delivered liquid mineral or supplement enters the outlet 222. As such, the peristaltic pump can operate at full speed while only delivering a small fraction of the pumped dose. As such, the present invention is able to achieve both high flow rate and high pressure.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

I claim:

1. A micro-dosing system for water mineralization process, the micro-dosing system comprising:
a bottle having a liquid mineral or supplement therein, said bottle having an opening in a neck extending therefrom, the neck opening to an interior volume of said bottle;
a cap affixed to the opening of the neck of said bottle, said cap having a channel formed through said cap, the channel communicating with the interior volume of said bottle, said cap having a return passage formed therein, the return passage communicating with the interior volume of said bottle;
a pump connected to the channel of said cap, said pump adapted to draw the liquid mineral or supplement through the channel; and
a splitter connected to said pump and with the channel of said cap, said splitter having an outlet formed thereon, said outlet passing a portion of the liquid mineral or supplement from the channel of said cap therefrom, said splitter having a return line communicating with the return passage of said cap, the return line adapted to pass a remainder of the liquid mineral or supplement back to the return passage of said cap and into the interior volume of said bottle.

2. The micro-dosing system of claim 1, wherein the channel said cap has a straw extending therefrom into the interior volume of said bottle.

3. The micro-dosing system of claim 1, wherein the return passage is annular and surrounds the channel of said cap.

4. The micro-dosing system of claim 1, wherein said cap has an upper surface extending across the opening of the neck of said bottle.

5. The micro-dosing system of claim 4, wherein said cap has an annular portion connected to the upper surface, the annular portion bearing against an inner wall of the neck of said bottle.

6. The micro dosing system of claim 5, said cap having a tubular portion extending downwardly therefrom, the tubular portion receiving a straw therein, the straw extending into the interior volume of said bottle.

7. The micro-dosing system of claim 1, wherein said pump is a peristaltic pump.

8. The micro-reducing system of claim 1, wherein said pump causes the liquid mineral or supplement to flow through the channel of said cap and through an inlet of said splitter and through the return line of said splitter and into the return passage of said cap.

9. The micro-dosing system of claim 1, wherein the outlet of said splitter is fed by a line extending from an inlet of said splitter.

10. The micro-dosing system of claim 9, wherein the line has a diameter that is a fraction of a diameter of the inlet of said splitter.

11. The micro-dosing system of claim 10, wherein the fraction is approximately one-tenth.

12. The micro-dosing system of claim 1, wherein said splitter has a chamber disposed between an inlet and the outlet thereof, the outlet of said splitter having a line opening to the chamber, the line having a diameter that is a fraction of a diameter of the inlet of said splitter.

13. The micro-dosing system of claim 12, wherein a circuitous path is formed in the chamber of said splitter, the liquid mineral or supplement flowing along the circuitous path prior to entering the line to the outlet of said splitter.

14. The micro-dosing system of claim 12, further comprising:
a first hose connecting the channel of said cap to an inlet of said pump;
a second hose connecting an outlet of said pump to the inlet of said splitter; and
a third hose connecting the return line of said splitter to the return passage of said cap.

15. A water filtering and mineralization apparatus comprising:
a system adapted to filter and mineralize water, said system having a container receptacle assembly formed or affixed thereto;
a bottle received by said container receptacle assembly, said bottle having a liquid mineral or supplement therein, the bottle having an opening in a neck extending therefrom, the neck opening to an interior volume of said bottle;
a cap affixed to the opening of the neck of said bottle, said cap having a channel formed through said cap, the channel communicating with the internal volume of said bottle, said cap having a return passage formed therein, the return passage communicating with the internal volume of said bottle;
a pump positioned adjacent the container receptacle assembly of said system, said pump connected to the channel of said cap, said pump adapted to draw the liquid mineral or supplement through the channel; and
a splitter connected to said pump and with the channel of said cap, said splitter having an outlet formed thereon, the outlet passing a portion of the liquid mineral or supplement from the channel of said cap into a manifold of said system so as to mix the liquid mineral or supplement with filtered water therein, said splitter having a return line communicating with the return passage of said cap, the return line adapted to pass a remainder of the liquid mineral or supplement back through the return passage of said cap and into the interior volume of said bottle.

16. The water filtering and mineralization apparatus of claim 15, wherein said pump is a peristaltic pump.

17. The water filtering and mineralization apparatus of claim 15, wherein the outlet of said splitter is fed by a line extending from an inlet of said splitter.

18. The water filtering and mineralization apparatus of claim 17, wherein the line has a diameter that is a fraction of a diameter of the inlet of said splitter.

19. The water filtering and mineralization apparatus of claim 15, wherein said splitter has a chamber disposed between the inlet and the outlet thereof, the outlet of said splitter having a line opening to the chamber, the line having a diameter that is a fraction of a diameter of the inlet of said splitter.

20. The water filtering and mineralization apparatus of claim 19, wherein a circuitous path is formed in the chamber of said splitter, the liquid mineral or supplement flowing along the circuitous path prior to entering the line to the outlet of said splitter.
